(19) United States
(12) Patent Application Publication
(10) Pub. No.: US 2007/0034783 A1
(43) Pub. Date: Feb. 15, 2007

(54) Multitasking radiation sensor

(76) Inventors: Jonas Ove Philip Eliasson, Copenhagen (DK); Jens Wagenblast Stubbe Ostergaard, Lejre (DK)

Correspondence Address: HARNESS, DICKEY & PIERCE, P.L.C., P.O. BOX 8910, RESTON, VA, 20195, US

(21) Appl. No.: 10/548,625

(22) PCT Filed: Mar. 12, 2004
(86) PCT No.: PCT/DK04/00166

§ 371 Date: Jun. 29, 2006

Related U.S. Application Data
(60) Provisional application No. 60/502,243, filed on Sep. 12, 2003.

(30) Foreign Application Priority Data
Mar. 12, 2003 (WO) PCT/DK03/00155

(51) Int. Cl. G06M 7/00

(52) U.S. Cl. 250/221

(57) ABSTRACT

A system and a method for using a single 2-D-radiation detector for simultaneously detecting radiation from a plurality of independent applications and for outputting a signal from which information relating to each application may be derived. The radiation from each application is provided to individuals parts of the sensor.

The present invention relates to a radiation sensor which is able to receive radiation relating to a plurality of independent functions.

One desired application is an optical touch screen.

Touch screens and systems where a single sensor is used for multiple purposes may be found in: U.S. Pat. No. 6,538,644, U.S. Pat. No. 5,679,930, U.S. Pat. No. 4,710,760, U.S. Pat. No. 4,484,179, U.S. Pat. No. 5,484,966, U.S. Pat. No. 6,172,667, and U.S. Pat. No. 5,065,185 as well as in JP 63143862, JP 08075659, and in JP 08149515.

In a first aspect, the invention relates to a system for deriving information relating to three independent applications, the system comprising a radiation sensor having a plurality of independent, radiation detecting elements, the system further comprising:

first means for providing radiation from a first application, the first means providing the radiation to a first group of the plurality of independent radiation detecting elements,

second means for providing radiation from a second application, the second means providing the radiation to a second group of the plurality of independent radiation detecting elements,

third means for providing radiation from a third application, the third means providing the radiation to a third group of the plurality of independent radiation detecting elements, no pairs of the first, second, and/or third groups of radiation detecting elements having any detecting elements in common,

means for obtaining a signal from the radiation sensor, the signal representing a detection of radiation from each of the plurality of radiation detecting elements, and

means for, on the basis of the signal, deriving information relating to the radiation detected from each of the first, second, and third applications.

In the present context, radiation may be both visible and IR/NIR radiation as well as UV radiation.

Independent applications are applications which operate and provide radiation independently of each other. Some applications may run while others are idle, and one application may provide the same radiation independently on the operation or radiation provided by the other applications.

Normally, the sensor will be a two-dimensional sensor, such as a CCD sensor, having the detecting elements positioned in a matrix of elements positioned in perpendicularly positioned lines or rows. The providing of the signal from this CCD may be that normally used.

Thus, even though the applications may be fully independent (like a camera, a touch pad and a fingerprint scanner), all applications may provide radiation which is determined and evaluated.

The signal output of the sensor will relate to the detections of all detecting elements. Knowing the groups of detecting elements, the separation may be performed with no large effort.

The means for deriving the information may be adapted to derive, from the radiation information, information relating to a property of each application.

Preferably, one or more of the first, second, and third means each comprises a radiation guiding element having a part adapted to receive radiation from the pertaining application, to guide the radiation to the pertaining group of detecting elements and to prevent the radiation from reaching detecting elements of the other groups of the first, second, and third groups. These means may actually extend to and abut the sensor in order to obtain its function.

Preferably, this radiation guiding element is adapted to maintain a directional and/or positional relation of the radiation guided. One manner of providing this is to provide it as a fibre bundle or a solid radiation transmissive element, information may be encoded in the direction or position of the radiation. This information may be that desired derived from the radiation information.

In a preferred embodiment, one of the first, second, and third groups are formed of detecting elements positioned adjacent to each other along at least one straight line or one or more of the first, second, and third groups are formed of detecting elements positioned adjacent to each other in a plurality of straight lines, the lines being positioned adjacent to each other. These lines are preferably co-extending.

Also, the system may comprise filtering means adapted to filter radiation incident on at least part of the detecting elements of one of the first, second and/or third groups.

In general, the radiation provided by the individual application may have any detectable property. Thus, a colour/polarization/direction/position/intensity may be a property which may be detected, form part of the signal and be derivable relating to the pertaining application.

In a preferred embodiment, the pertaining application is adapted to receive radiation from a radiation emitter and to provide radiation having a predetermined intensity/wavelength pattern on at least one of the lines of the detecting element, the pattern depending on the position of the radiation emitter, such as in relation to a predetermined element. This pattern may be a colour pattern or an intensity pattern which may describe one or more situations of the application.

In fact, other reasons also exist for providing optical filters in front of all or part of the detecting elements, such as in order to be able to provide normal colour images.

Preferably, the application is adapted to receive radiation emitted in two different directions by the radiation emitter and to transmit the radiation from the two directions through one or more apertures/lenses/pinholes prior to detection by the detecting elements.

In this manner, the application may be a touch pad or an optical keyboard as described in e.g. PCT/DK03/00155.

Thus, the positions of the radiation on the detector may describe the angle of incidence of the radiation on the aperture etc and thereby the position. Standard triangulation may be used for that determination, when the position information is derived from the information from the sensor.

In one situation, the application is adapted to provide the radiation received from one direction with a predetermined wavelength, and the pertaining means comprises filtering means adapted to filter the radiation incident on at least part of the detecting means of the group. Then, the peaks are more easily separatable in that the peaks may be determined by different parts of the sensor (with different filters).

In one embodiment, some of the pertaining group(s) is/are provided at an outer edge portion of the sensor, and wherein a group is defined at a centre of the sensor, the means relating the centre group comprising means for providing an image of surroundings to the system to the centre group. This may be a standard camera.

In a particular embodiment, the radiation detecting means of the sensor are provided in a number of co-extending rows, and wherein the radiation detecting means in one row are displaced a fraction of a width of a radiation detecting means in relation to the radiation detecting means of an adjacent row. Thus, instead of the normal matrix positioning of the detecting means, a shift is provided. This has the advantage that when a radiation spot, such as an oblong spot oblong along a direction at an angle to the direction of the rows) is provided to a plurality of the rows, a better determination of the position of e.g. the peak of the spot may be determined in that the individual rows detect different positions of the peak.

In order to obtain a better adaptability, the first means may be adapted to provide radiation from one of a number of applications, the system further comprising selecting means for selecting which of the number of applications provides radiation to the first means. Thus, a number of applications may be adapted to provide radiation to the same detecting means. The selecting means may be means for preventing radiation from reaching the detecting means, such as shutters, or the means may simply prevent radiation from being provided, such as radiation providing means providing radiation for the applications to provide to the first means. Such radiation providing means may be means for providing radiation to a touch pad, where the touch pad provides radiation for the present system, which radiation comprises information as to a selected position on the touch pad. In addition, in a specific embodiment, multiple applications may, in fact, provide radiation at the same time, where separating means are provided for separating the information, subsequent to detection of the radiation, from each application. This separation may be due to a difference in modulation of the radiation, on the basis of a wavelength of the radiation, or the like.

Preferably, the system further comprises the first, second and third applications, the first, second and third applications being adapted to provide radiation independently of each other.

Such applications may be touch pads, finger print scanners, cameras, or other applications all providing radiation with information encoded therein relating to a property or measurement of the application.

In the present context, two applications are independent if the radiation there from or the information represented by the radiation is independent.

In a second aspect, the invention relates to a method of providing information relating to a plurality of independent applications, the method comprising:

providing a radiation sensor having a plurality of independent, radiation detecting elements,

a first step of providing radiation from a first application to a first group of the plurality of independent radiation detecting elements,

a second step of providing radiation from a second application to a second group of the plurality of independent radiation detecting elements,

a third step of providing radiation from a third application to a third group of the plurality of independent radiation detecting elements, no pairs of the first, second, and/or third groups of radiation detecting elements having any detecting elements in common,

obtaining a signal from the radiation sensor, the signal representing a detection of radiation from each of the plurality of radiation detecting elements, and

deriving, on the basis of the signal, information relating to the radiation detected from each of the first, second, and third applications.

Preferably, one or more of the first, second, and third steps each comprises receiving, in a radiation guiding element, radiation from the pertaining application, guiding the radiation to the pertaining group of detecting elements and preventing the radiation from reaching detecting elements of the other groups of the first, second, and third groups.

Alternatively or in addition, one of the first, second, and third steps may comprise providing the radiation to a group formed of detecting elements positioned adjacent to each other along at least one straight line.

Also, one of the first, second, and third steps could comprise providing the radiation to a group formed of detecting elements positioned adjacent to each other in a plurality of straight lines, the lines being positioned adjacent to each other. In that situation, the lines could be co-extending.

The method may further comprise the step of filtering radiation incident on at least part of the detecting elements of one of the first, second and/or third groups.

The pertaining application preferably receives radiation from a radiation emitter and provides radiation having a predetermined intensity/wavelength pattern on at least one of the lines of the detecting element, the pattern depending on the position of the radiation emitter. Then, the application, in one embodiment, receives radiation emitted in two different directions by the radiation emitter and transmits the radiation from the two directions through one or more apertures/lenses/pinholes prior to detection by the detecting elements. Again, then, the application may provide the radiation received from one direction with a predetermined wavelength, and the pertaining step filters the radiation incident on at least part of the detecting means of the group.

Also, the pertaining group(s) may be provided at an outer edge portion of the sensor, and a group be defined at a centre of the sensor, the means relating the centre group providing an image of surroundings to the system to the centre group.

In one particular embodiment, the providing step comprises providing a sensor, the radiation detecting means of which are provided in a number of co-extending rows, and wherein the radiation detecting means in one row are displaced a fraction of a width of a radiation detecting means in relation to the radiation detecting means of an adjacent row, and wherein at least one of the first, second and third steps comprises providing the radiation to at least two adjacent rows. Preferably, the radiation is intensity modulated and the same modulation is provided on each of the rows in order for the same rows to detect different positions of the same (or at least substantially the same) radiation “pattern”.

In another embodiment, the first step comprises providing radiation from one of a number of applications, the first step further comprising the step of selecting which of the number of applications provides radiation to the first means. As mentioned above, different means and steps may be used for preventing radiation from multiple of the applications from being provided or reaching the detecting means. Alternatively, radiation from multiple applications may be allowed to be detected, where a step is then provided for separating the information from the applications.

Finally, the method may further comprise the step of performing the first, second and third applications, the first, second and third applications providing radiation independently of each other.

In the following, the preferred embodiment will be described with reference the drawings, wherein:

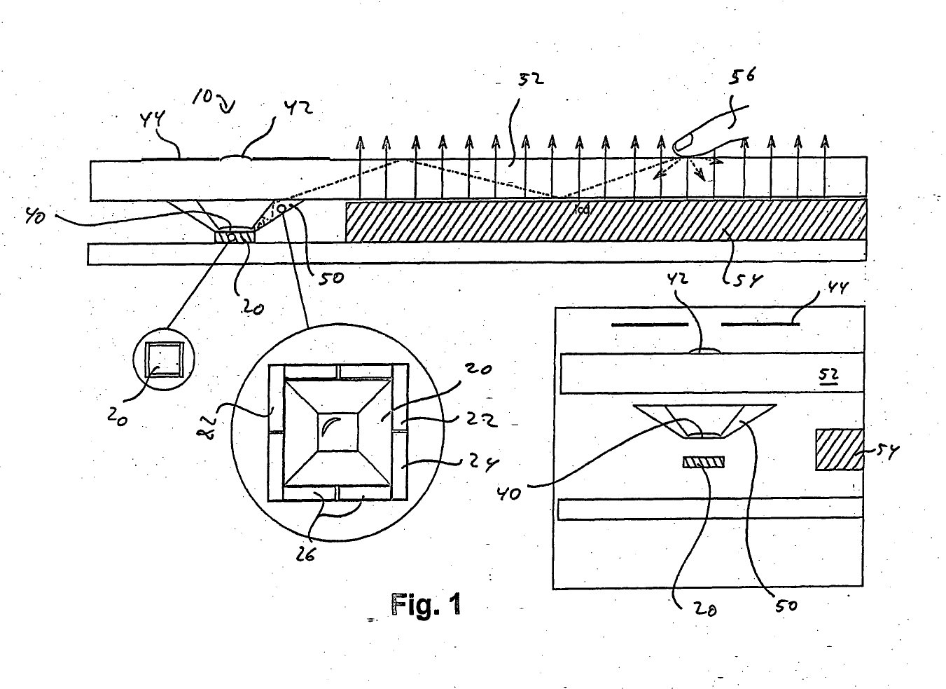

FIG. 1 illustrates a system 10 having a two-dimensional CCD 20 having a two-dimensional array of radiation sensitive detectors,

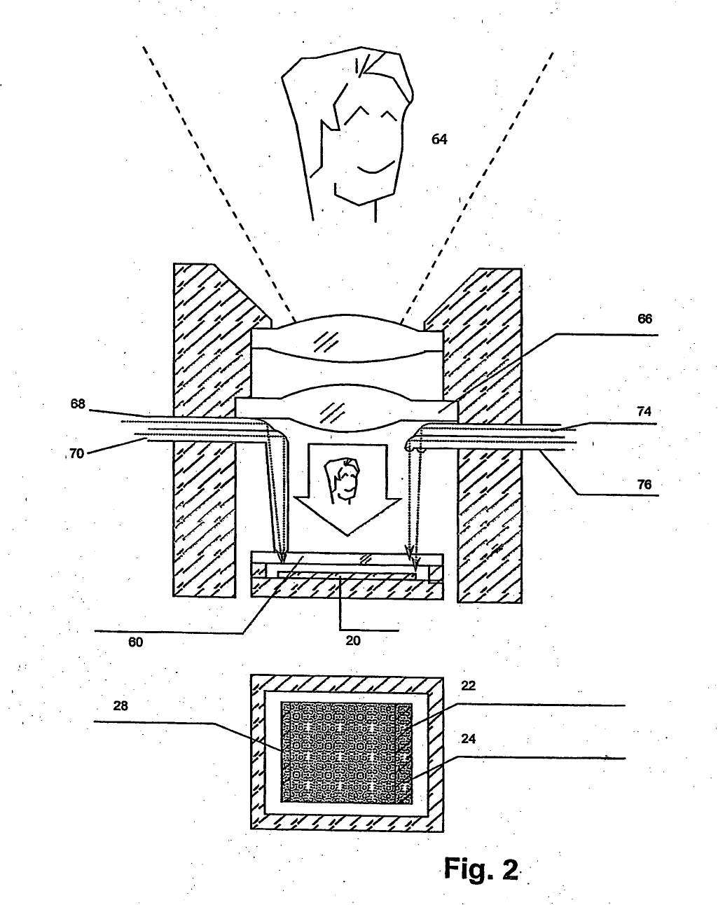

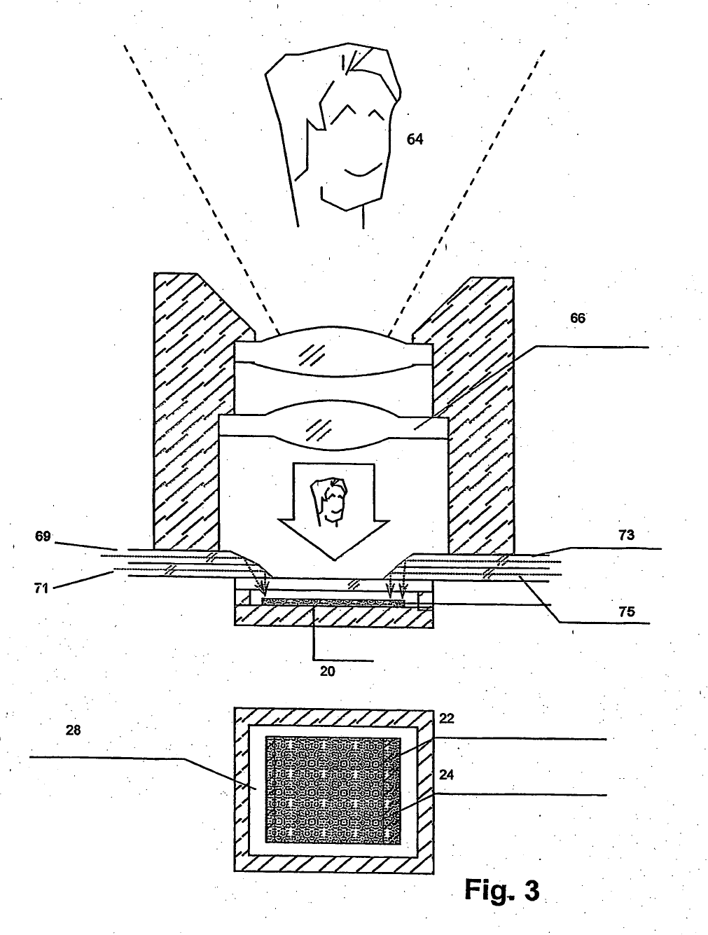

FIGS. 2 and 3 illustrate another embodiment,

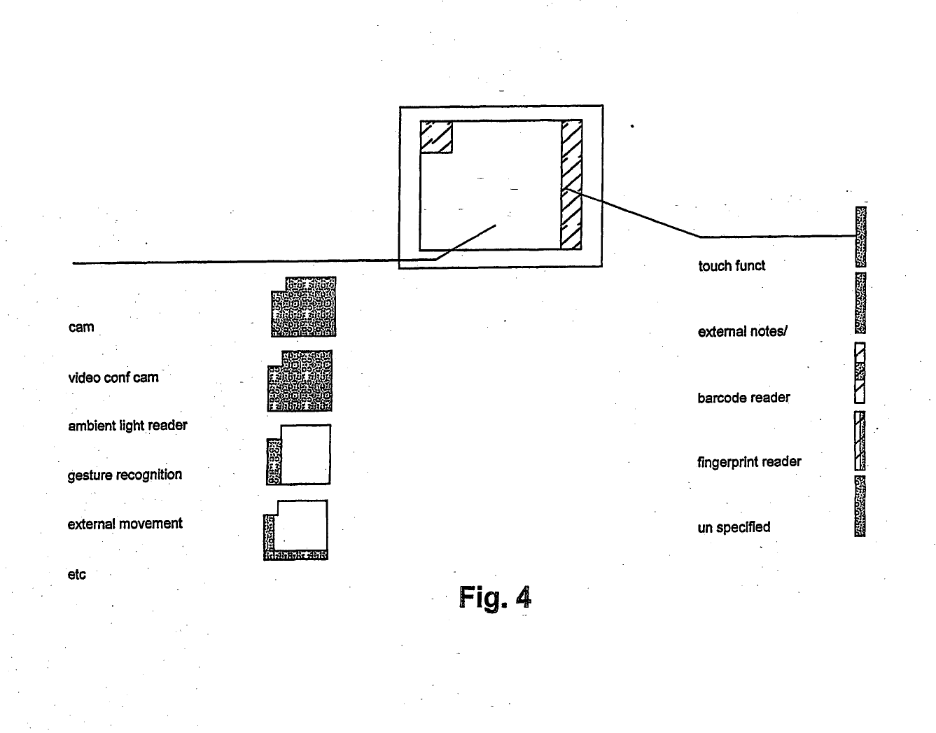

FIG. 4 illustrates re-allocation of areas on the sensor, and

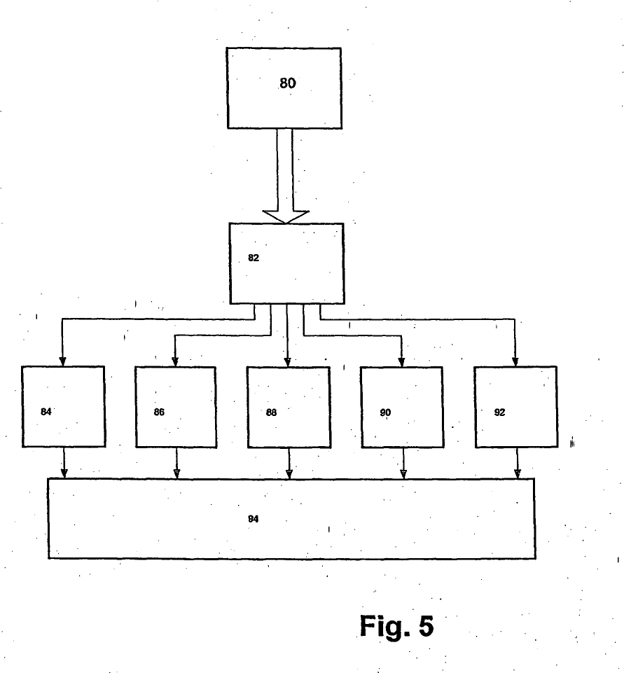

FIG. 5 illustrates the data handling and providing of the system.

This array of detectors is divided into areas 22, 24, 26, and 28 and a remaining centre area.

The centre area is used as a camera, where radiation from the surroundings is provided on this centre area using lenses 40 and 42 and an absorbing element 44 ensuring that ambient light does not interfere with the image forming process.

The outer areas 22-28 may be used for a number of purposes of which one is illustrated.

It is seen that the areas 22-28 are provided as elongate areas and may, in fact be provided as single lines of light sensitive detectors or a plurality of co-extending lines adjacent to each other.

The application indicated is a touch screen where a finger 56 touches an upper surface of a light transmissive element 52. The element 52 is illuminated from the opposite surface by a monitor or screen 54. The radiation from this screen 54 is reflected by the finger 56 and is transmitted via internal reflection toward the sensor 20.

The position of touch of the finger 56 is determined by simple triangulation by detecting the direction between the point of touch and two predetermined points where e.g. a lens/aperture/pinhole is positioned. This element will provide an angle sensitivity to the sensor in that the light beam transmitted from the lens/aperture/pinhole toward a line of detecting elements will be incident on a point or an area which will determine the actual angle. Two such measurements will be sufficient to determine the position of touch.

The overlapping beams may be detected using a single line (see 26) of detecting elements and the resulting peaks determined, whereby triangulation may be used for determining the position.

Thus, two parts of a single line (see 22 and 24) of detecting elements may be used or two separate lines may be used. Also, the radiation from the individual aperture/lens/pinhole may be provided with a predetermined wavelength (or wavelength interval) selected also by a filter at a line, whereby interference of other light beams may be avoided.

In order to guide the light from this application to the line(s) of detecting elements desired, a transmissive member is provided which is adapted to be positioned adjacent to or abut the sensor 20. The member comprises a central part defining the lens 40 and an edge part 50 adapted to receive the radiation from the application and guide it to the desired detector line(s).

The edge part 50 is a solid, radiation transmissive element maintaining the direction of the radiation transmitted in order to maintain the credibility of the intensity pattern detected.

Similar parts 50 are provided for three other applications using a.o. the parts 22-28 in the same manner.

The parts 50 both guide the radiation from the individual applications to the desired detecting elements and at the same time prevent that radiation from disturbing any of the other detecting elements. Also, they ensure that light from the lens 42 to the lens 40 does not enter the elements 50 and interfere with the detecting elements relating thereto.

Thus, it is seen that the sensor described is, in fact, adapted to also receive radiation from three other applications, such as finger print sensors, other touch pads as that described, radiation from external presentations where radiation emitters external to the system emit the radiation, where this radiation is detected as with the application described but collected using lenses adapted to collect radiation from outside the system.

A fingerprint scanner may be provided as the touch screen where, however, a slot (where the radiation may be exposed to the translating finger) is provided at the surface of the transmissive member 52. When a finger is translated over that slot, the ridges and valleys of the fingerprint will reflect/scatter differently, whereby a pattern is emitted which may be detected by the angle sensitive detectors. In this manner, only a single aperture/lens is required and a single line of sensing elements need be used.

Other applications may require or facilitate other shapes of the individual groups of sensor elements, such as light intensity meters monitoring the light intensity of ambient light in order to e.g. determine features of the image capture process or the illumination properties of the screen 54.

Suitable applications are also described in PCT/DK03/00155 and the applicants' co-pending US applications filed 12 Sep. 2003.

Thus, a standard CCD may be used as well as the standard manner of providing the image data or information there from.

This information now may relate to a plurality of different and independent applications but may, nevertheless, be derived and separated quite easily. Also, the system may use the same sensor for a plurality of applications without having to provide mechanical or optical blinders in order to ensure that no application interferes with others.

FIG. 2 illustrates another embodiment where the sensor 20 is covered by a protection or cover layer 60. As is the situation in the first embodiment, part of the sensor 20 may provide a standard image of the surroundings via a lens system 66, such as standard camera optics.

Other applications provide radiation to the sensor 20 via parallel radiation guides 68 and 70 which provide radiation in a direction parallel to the sensor 20 and reflect the radiation toward the same area (such as the area 28 in FIG. 1). A similar setup is provided at another area (such as the area 24 in FIG. 1) of the sensor where the radiation guides 74 and 76 provide light onto the same area.

In one situation, the applications providing light into the guides 68 and 70 may provide radiation at the same time. A separation of the radiation or the resulting information from the sensor 20 is then required. This separation may be obtained by providing the radiation from the individual applications with different wavelengths or polarization, whereby separation may be performed at the sensor 20. Also, different modulation frequencies may be provided to the radiation, whereby separation is performed on the signals or the information derived from the sensor subsequent to detection of the radiation.

In another situation, it may be desired or required that the applications do not transmit radiation at the same time. In that situation, the radiation from an application may be attenuated or prevented from reaching the sensor, using e.g. shutters. If the applications themselves require a light emitter for generating the radiation which eventually is transmitted toward the sensor 20, this light emitter may be turned off in order to prevent radiation from that application.

FIG. 3 illustrates an embodiment similar to that of FIG. 2, where alternatives to the radiation guides 68, 70, 74, and 76 are illustrated. These radiation guides either transmit the radiation toward the sensor (guides 73 and 75) or abut the cover layer (guides 69 and 71) in order to prevent stray radiation and optimize the intensity of radiation received by the sensor 20.

An advantage obtained using the radiation guides 73 and 75 is that the area used by these guides may also be used for the camera application in that radiation from the lens system 66 may also impinge on that area 22/24.

FIG. 4 illustrates the overall detector surface of the sensor 20. Depending on the applications, different areas thereof may be allocated solely for a given application. However, it may also be desired that at least some of the areas may, in fact, be used for multiple applications either at the same time or one at the time.

Thus, as is seen in FIG. 4, a large area may be used (the dark area) when a camera is desired, where a smaller area, such as only one or a few pixels, may be used as a sensor for detecting ambient light in order to control an electronic shutter speed of the camera.

Touch pads may require other areas for different applications, and the individual applications may be turned on or off and individual areas reallocated depending on the size of the area required by the application in order to detect the characteristics desired. An example is a position or angle detection requiring a row of detecting elements. In this situation, the radiation from the ambient light detector may be rerouted to another area of the sensor 20, or shut down entirely, in order to “free” a full row of the sensor for the touch pad.

In FIG. 5, the data processing is illustrated.

It is clear that no matter the radiation detected by the sensor 20, the internal processing of the sensor 20 is the same, and the output thereof is always e.g. one or more strings or vectors of numbers relating to each pixel thereof.

In a first subsequent step (80), the analogue signals from the sensor are converted into digital signals which, in a de-multiplexing step 82 are forwarded to individual application specific calculations 84-92 receiving the digital values and calculating the actual information encoded in the radiation from the pertaining application.

Naturally, the de-multiplexing step 82 may change the de-multiplexing depending on the actual areas on the sensor used for the individual areas on the sensor, when these may be freely allocated or re-allocated.

The calculations 84-92 are each programmed in order to derive the specific information desired. Thus, the calculation relating to a camera will output an image taken. An ambient light detector will output a value relating to the ambient light intensity. This value may be used by the image calculation or a backlighting of a monitor or display.

A calculation relating to a touch pad will provide information relating to a position or another feature of the touch pad, such as a depression of a mouse button. This information may be used subsequently in application specific software 94 which then receives this information and operates the system accordingly. This operation may be the ending or starting of new processes, the taking of an image, the making of a phone call, controlling menus or the like, depending on the actions taken resulting in the radiation received and interpreted.

Naturally, the present sensor 20 and electronics may be provided as one, two or a number of chips, such as ASIC's, DSPs, FPGAs or the like.

In addition to the above applications, a number of other applications may be used or provided. These applications are described in the Applicants US applications filed on 12 Sep. 2003.

1.-28. (canceled)

29. A system for deriving information relating to three independent applications, the system comprising a radiation sensor having a plurality of independent, radiation detecting elements, the system further comprising:
first means for providing radiation from a first application, the first means providing the radiation to a first group of the plurality of independent radiation detecting elements,
second means for providing radiation from a second application, the second means providing the radiation to a second group of the plurality of independent radiation detecting elements,
third means for providing radiation from a third application, the third means providing the radiation to a third group of the plurality of independent radiation detecting elements, no pairs of the first, second, and/or third groups of radiation detecting elements having any detecting elements in common,
one or more of the first, second, and third means each comprises a radiation guiding element having a part adapted to receive radiation from the pertaining application, to guide the radiation to the pertaining group of detecting elements and to prevent the radiation from reaching detecting elements of the other groups of the first, second, and third groups, each radiation guiding element being adapted to maintain a directional and/or positional relation of the radiation guided,
means for obtaining a signal from the radiation sensor, the signal representing a detection of radiation from each of the plurality of radiation detecting elements, and
means for, on the basis of the signal, deriving information relating to the radiation detected from each of the first, second, and third applications.

30. A system according to claim 29, wherein each radiation guiding element is a solid radiation transmissive element.

31. A system according to claim 29, wherein each radiation guiding element extends to and abut the sensor.

32. A system according to claim 29, wherein one of the first, second, and third groups are formed of detecting elements positioned adjacent to each other along at least one straight line.

33. A system according to claim 29, wherein one of the first, second, and third groups are formed of detecting elements positioned adjacent to each other in a plurality of straight lines, the lines being positioned adjacent to each other.

34. A system according to claim 33, wherein the lines are co-extending.

35. A system according to claim 32, further comprising filtering means adapted to filter radiation incident on at least part of the detecting elements of one of the first, second and/or third groups.

36. A system according to claim 32, wherein the pertaining application is adapted to receive radiation from a radiation emitter and to provide radiation having a predetermined intensity/wavelength pattern on at least one of the lines of the detecting element, the pattern depending on the position of the radiation emitter.

37. A system according to claim 36, wherein the application is adapted to receive radiation emitted in two different directions by the radiation emitter and to transmit the radiation from the two directions through one or more apertures/lenses/pinholes prior to detection by the detecting elements.

38. A system according to claim 37, wherein the application is adapted to provide the radiation received from one direction with a predetermined wavelength, and wherein the pertaining means comprises filtering means adapted to filter the radiation incident on at least part of the detecting means of the group.

39. A system according to claim 32, wherein the pertaining group(s) is/are provided at an outer edge portion of the sensor, and wherein a group is defined at a centre of the sensor, the means relating the centre group comprising means for providing an image of surroundings to the system to the centre group.

40. A system according to claim 29, wherein the radiation detecting means of the sensor are provided in a number of co-extending rows, and wherein the radiation detecting means in one row are displaced a fraction of a width of a radiation detecting means in relation to the radiation detecting means of an adjacent row.

41. A system according to claim 29, wherein the first means are adapted to provide radiation from one of a number of applications, the system further comprising selecting means for selecting which of the number of applications provides radiation to the first means.

42. A system according to claim 29, the system further comprising the first, second and third applications, the first, second and third applications being adapted to provide radiation independently of each other.

43. A method of providing information relating to a plurality of independent applications, the method comprising:
providing a radiation sensor having a plurality of independent, radiation detecting elements,
a first step of providing radiation from a first application to a first group of the plurality of independent radiation detecting elements,
a second step of providing radiation from a second application to a second group of the plurality of independent radiation detecting elements,
a third step of providing radiation from a third application to a third group of the plurality of independent radiation detecting elements, no pairs of the first, second, and/or third groups of radiation detecting elements having any detecting elements in common,
wherein one or more of the first, second, and third steps each comprises receiving, in a radiation guiding element, radiation from the pertaining application, guiding the radiation to the pertaining group of detecting elements and preventing the radiation from reaching detecting elements of the other groups of the first, second, and third groups, the radiation guiding step comprises maintaining a directional and/or positional relation of the radiation guided,
obtaining a signal from the radiation sensor, the signal representing a detection of radiation from each of the plurality of radiation detecting elements, and
deriving, on the basis of the signal, information relating to the radiation detected from each of the first, second, and third applications.

44. A method according to claim 43, wherein the radiation guiding step comprises guiding the radiation in a solid radiation transmissive element.

45. A method according to claim 43, wherein the radiation guiding step comprises guiding the radiation in means extending to and abutting the sensor.

46. A method according to claim 43, wherein one of the first, second, and third steps comprises providing the radiation to a group formed of detecting elements positioned adjacent to each other along at least one straight line.

47. A method according to claims 43, wherein one of the first, second, and third steps comprises providing the radiation to a group formed of detecting elements positioned adjacent to each other in a plurality of straight lines, the lines being positioned adjacent to each other.

48. A method according to claim 47, wherein the lines are co-extending.

49. A method according to claim 46, further comprising the step of filtering radiation incident on at least part of the detecting elements of one of the first, second and/or third groups.

50. A method according to claim 46, wherein the pertaining application receives radiation from a radiation emitter and provides radiation having a predetermined intensity/wavelength pattern on at least one of the lines of the detecting element, the pattern depending on the position of the radiation emitter.

51. A method according to claim 50, wherein the application receives radiation emitted in two different directions by the radiation emitter and transmits the radiation from the two directions through one or more apertures/lenses/pinholes prior to detection by the detecting elements.

52. A method according to claim 50, wherein the application provides the radiation received from one direction with a predetermined wavelength, and wherein the pertaining step filters the radiation incident on at least part of the detecting means of the group.

53. A method according to claim 46, wherein the pertaining group(s) is/are provided at an outer edge portion of the sensor, and wherein a group is defined at a centre of the sensor, the means relating the centre group providing an image of surroundings to the system to the centre group.

54. A method according to claim 43, wherein the providing step comprises providing a sensor, the radiation detecting means of which are provided in a number of co-extending rows, and wherein the radiation detecting means in one row are displaced a fraction of a width of a radiation detecting means in relation to the radiation detecting means of an adjacent row, and wherein at least one of the first, second and third steps comprises providing the radiation to at least two adjacent rows.

55. A method according to claim 43, wherein the first step comprises providing radiation from one of a number of applications, the first step further comprising the step of selecting which of the number of applications provides radiation to the first means.

56. A method according to claim 43, the method further comprising the step of performing the first, second and third applications, the first, second and third applications providing radiation independently of each other.
